(19) United States
(12) Patent Application Publication
(10) Pub. No.: US 2018/0060849 A1
(43) Pub. Date: Mar. 1, 2018

(54) MEAL MAKING SYSTEM

(71) Applicant: GINO CREATION CO., LTD., Taipei City (TW)

(72) Inventor: TSUNG-HSI LIU, Taipei City (TW)

(21) Appl. No.: 15/244,295

(22) Filed: Aug. 23, 2016

(51) Int. Cl. G06Q 20/20; G06K 7/14

(52) U.S. Cl. CPC G06Q 20/202; G06K 7/1417; G06K 7/1413

(57) ABSTRACT

Disclosed is a meal making system that can be adapted to every commonly used POS machine, wherein each kind of meal making process is preset. Thus, it is easy to make meals quickly and correctly. The meal making system comprises a pre-processing system and a post-processing system. The post-processing system comprises processing devices and each processing device comprises at least one meal making machine, a scanner and a second positioning means. Each meal making machine has an operation interface. The pre-processing system is used to set the meal making process for each meal, wherein an identification code is generated for each set meal making process. The scanner reads the identification code and the operation interface of each meal making machine displays the steps of the meal making process corresponding to the identification code. After an operator operates each needed meal making machine, the meal making process is finished.

### BACKGROUND OF THE INVENTION

### 1. Field of the Invention

The instant disclosure relates to a meal making system; in particular, to a meal making system that can be adapted to any kind of POS (Point of Service) system.

### 2. Description of Related Art

The food and beverage industry has grown with the customers' needs. For example, in terms of coffee, there are many options for customers, such as the Espresso, the Americano, the Syphon coffee or the like. These different kinds of coffee are made of different kinds of beans and there may be different ways to grind the beans. Several grinders need to be used in different coffee making processes. Speaking of tea, there are more options for the customers to choose from. In addition, the size of the beverage is another decision for the customers to make, such as the small size, the medium size and the large size. Moreover, there are several kinds of syrups for the customers to choose from and the sugar usage is another concern for the customers, such as full sugar, half sugar, less sugar or sugar free. Therefore, it always takes time to train the clerks to make different kinds of beverages. However, it is still hard for the clerks to learn and remember all kinds of meal making processes to make coffee, tea and other beverages, and inevitably the clerks make mistakes.

Generally, when buying a meal, the first thing to do is make an order. Usually, the clerk uses the POS (Point of Services) machine to help the customer make his order. By using the POS machine, the clerk can input the information relevant to the ordered meal, such as the item, the meal size, the sugar usage, the price or the like. There are more and more different kinds of POS machines and corresponding applications used in different restaurants, coffee shops and beverage shops. However, it is difficult to make a meal making system that can be adapted to all kinds of POS machines and corresponding applications.

### SUMMARY OF THE INVENTION

The instant disclosure provides a meal making system. This meal making system is easy to operate, and thus it will not take much time to train new employees. Also, there is a less possibility that the clerks make mistakes when operating the meal making system. All data generated when a meal is made will be automatically recorded as references in the future and any needed equipment can be added to this meal making system. Moreover, this meal making system can be connected to any POS system.

The meal making system provided by the instant disclosure comprises a pre-processing system and a post-processing system. The pre-processing system comprises a setup unit for a user to preset each meal making process of each kind of meal. An identification code is correspondingly generated after the user finishes presetting each meal making process of each kind of meal. The post-processing system comprises a plurality of processing devices and receives each preset meal making process of each kind of meal from the pre-processing system. An operator operates the processing devices to finish each preset meal making process of each kind of meal, and each processing device comprises at least one meal making machine for the operator to execute the steps of each preset meal making process. The processing device comprises a scanner to scan the identification code of each meal making process of each kind of meal. The meal making machine comprises an operation interface to display the steps of each preset meal making process for the operator to operate. During the time when the operator operates the processing devices to finish the preset meal making process, the scanner scans the identification code, the operation interface displays the corresponding steps of the preset meal making process, and the operator operates the operation interface to finish all steps of the preset meal making process. The operation interface displays the corresponding steps of the preset meal making process according to the identification code, so the system specifications of the pre-processing system and the post-processing system can be the same or different.

In one embodiment of the meal making system provided by the instant disclosure, the identification code is a barcode, a pattern code, a QR code or a text code.

In one embodiment of the meal making system provided by the instant disclosure, the user and the operator are different people or the same person to preset and finish each meal making process of each kind of meal.

In one embodiment of the meal making system provided by the instant disclosure, the pre-processing system is a POS terminal, a laptop or a personal computer.

In one embodiment of the meal making system provided by the instant disclosure, the setup unit is a smart phone, a tablet or a POS terminal.

In one embodiment of the meal making system provided by the instant disclosure, the processing devices comprise a first processing device, a second processing device and a third processing device. The first processing device comprises a first meal making machine and a second meal making machine. The second processing device comprises a third meal making machine and a fourth meal making machine. The third processing device comprises a fifth meal making machine and a sixth meal making machine. The first meal making machine and the second meal making machine are a first grinder and a second grinder, the third meal making machine and the fourth meal making machine are a first beverage machine and a second beverage machine, and the fifth meal making machine and the sixth meal making machine are a first syrup machine and a second syrup machine.

In one embodiment of the meal making system provided by the instant disclosure, the meal making system further comprises a plurality of tray devices. Each identification code is attached at a predetermined position on the tray device, and each tray device has a first positioning means.

In one embodiment of the meal making system provided by the instant disclosure, the tray device supports a container and the container is a beverage cup, a coffee cup, a meal bowl or a soup bowl.

For further understanding of the instant disclosure, reference is made to the following detailed description illustrating the embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a meal making system of one embodiment of the instant disclosure.

FIG. 2 shows a schematic diagram of a setup image of a grinder in one embodiment of the instant disclosure.

FIG. 3 shows a schematic diagram of a setup image of a beverage machine in one embodiment of the instant disclosure.

FIG. 4 shows a schematic diagram of a setup image of a beverage machine in another embodiment of the instant disclosure.

FIG. 5 shows a schematic diagram of a setup image of a syrup machine in one embodiment of the instant disclosure.

FIG. 6 shows a schematic diagram of a setup image of a beverage machine in still another embodiment of the instant disclosure.

FIG. 7 shows a schematic diagram of a setup image of a beverage machine in still another embodiment of the instant disclosure.

FIG. 8 shows a schematic diagram of a setup image of a syrup machine in another embodiment of the instant disclosure.

FIG. 9 shows a schematic diagram of a tray device of one embodiment of the instant disclosure.

FIG. 10 shows a schematic diagram of a tray device and a container of one embodiment of the instant disclosure.

FIG. 11 shows a schematic diagram of an operation image of a grinder in one embodiment of the instant disclosure.

FIG. 12 shows a schematic diagram of an operation image of a beverage machine in one embodiment of the instant disclosure.

FIG. 13 shows a schematic diagram of an operation image of a syrup machine in one embodiment of the instant disclosure.

FIG. 14 shows a schematic diagram of an operation image of a grinder in another embodiment of the instant disclosure.

FIG. 15 shows a schematic diagram of an operation image of a beverage machine in another embodiment of the instant disclosure.

FIG. 16 shows a schematic diagram of an operation image of a syrup machine in another embodiment of the instant disclosure.

### DETAILED DESCRIPTION OF PREFERRED EMBODIMENTS

A meal making system is provided by the instant disclosure, which can be adapted to many kinds of POS systems that are commonly used in the food and beverage industry. This meal making system is the first to preset a meal making process for each kind of meal and steps thereof, and to execute the steps of each preset meal making process according to a meal order sent from the POS system. The meal making system provided by the instant disclosure is easy to use, and by using it, all meals can be quickly and correctly provided to the consumers. Additionally, this meal making system can receive relevant data downloaded through the Internet and can communicate with other control devices to realize an automatic management for the entire system. The POS system can be, for example, a customized POS system or any POS system that is commonly used in the food and beverage industry.

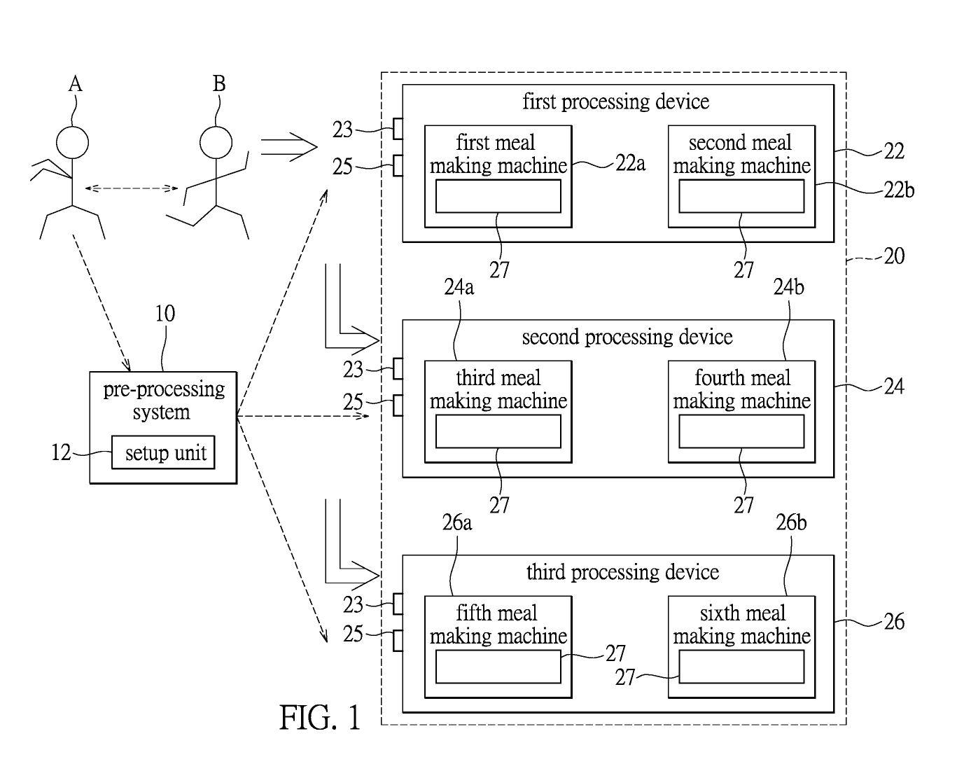

Referring, FIG. 1 shows a block diagram of a meal making system of one embodiment of the instant disclosure. The meal making system comprises a pre-processing system 10 and a post-processing system 20. The pre-processing system 10 comprises a setup unit 12. The post-processing system 20 comprises a first processing device 22, a second processing device 24 and a third processing device 26. The first processing device 22 comprises a first meal making machine 22a and a second meal making machine 22b, the second processing device 24 comprises a third meal making machine 24a and a fourth meal making machine 24b, and a third processing device 26 comprises a fifth meal making machine 26a and a sixth meal making machine 26b. The processing devices 22, 24 and 26, respectively, have a scanner 23 and a second positioning means 25. The meal making machines 22a, 22b, 24a, 24b, 26a and 26b, respectively, have an operation interface 27. As shown in FIG. 1, a user A and an operator B can both use this meal making system.

The pre-processing system 10 is for a user to preset each meal making process of each kind of meal. The meal making system records the information relevant to many kinds of meals. Each meal has its meal making process, and each meal making process comprises a plurality of steps. A user A can use the setup unit 12 in the pre-processing system 10 to preset each meal making process of each kind of meal, and an identification code is correspondingly generated after the user finishes presetting each meal making process of each kind of meal.

For example, the pre-processing system 10 can be a POS terminal, a laptop or a personal computer, and the setup unit 12 can be a smart phone or a tablet. Thus, in another embodiment, instead of using the setup unit 12, a user can directly use the pre-processing system 10 to preset each meal making process of each kind of meal.

The post-processing system 20 receives each preset meal making process of each kind of meal from the post-processing system 10. The data transmission between the pre-processing system 10 and the post-processing system 20 can be implemented through wireless communication or wired communication. Moreover, the data relevant to any meal making process can be can be downloaded through the Internet by this meal making system, and an auto management for the entire meal making system can be realized by some control devices that can communicate with this meal making system.

The first processing device 22, the second processing device 24 and the third processing device 26 respectively execute one step of a meal making process. Thus, an operator B can use the first processing device 22, the second processing device 24 and the third processing device 26 to finish an entire meal making process, wherein the first processing device 22 at least comprises a first meal making machine 22a and a second meal making machine 22b, the second processing device 24 at least comprises a third meal making machine 24a and a fourth meal making machine 24b, and the third processing device 26 at least comprises a fifth meal making machine 26a and a sixth meal making machine 26b. Each meal making process has a corresponding identification code. The scanners 23 of the first processing device 22, the second processing device 24 and the third processing device 26 are to scan the identification code of each meal making process. Details about the second positioning means 25 are later provided by FIG. 9 and its corresponding description.

For example, the first processing device 22 can be a grinder, and the first meal making machine 22a and the second meal making machine 22b are respectively a first grinder and a second grinder, which can grind beans or other food. The first meal making machine 22a and the second meal making machine 22b have the same meal making function. Likewise, for example, the second processing device 24 can be a beverage machine, and the third meal making machine 24a and the fourth meal making machine 24b are respectively a first beverage machine and a second beverage machine; the third processing device 26 can be a syrup machine, and the fifth meal making machine 26a and the sixth meal making machine 26b are respectively a first syrup machine and a second syrup machine.

The grinder, the beverage machine and the syrup machine are only examples for illustrating the processing devices 22, 24 and 26. In other words, the processing devices 22, 24 and 26 can also be, for example, ovens, electric cookers, electric casseroles, microwave ovens, induction cookers, ceramic stoves or other food processing or meal making machines.

The operation interface 27 of each meal making machine 22a, 22b, 24a, 24b, 26a and 26b displays steps of each meal making process of each kind of meal. In practice, the operation interface 27 can be, for example, a touch panel, and the operator B can operate the touch panel to execute the steps of a meal making process of a meal.

The following description is to illustrate how the operator B operates the processing devices 22, 24 and 26 to finish a preset meal making process of a meal. First, the scanners 23 of the first processing device 22, the second processing device 24 and the third processing device 26 respectively scan an identification code of the preset meal making process of the meal, and then the operation interface 27 of the first processing device 22 displays the step of the preset meal making process that the first meal making machine 22a or the second meal making machine 22b needs to execute, the operation interface 27 of the second processing device 24 displays the step of the preset meal making process that the third meal making machine 24a or the fourth meal making machine 24b needs to execute, and the operation interface 27 of the third processing device 26 displays the step of the preset meal making process that the fifth meal making machine 26a or the sixth meal making machine 26b needs to execute. The operator B can operate each meal making machine to execute each step of the preset meal making process of a meal. The operation interface 27 displays the corresponding steps of the preset meal making process only according to the identification code, so the system specifications of the pre-processing system 10 and the post-processing system 20 can be either the same or different. In brief, the meal making system provided by the instant disclosure can be adapted to any kind of POS system.

The identification code corresponding to each meal making process of each meal can be, for example, a barcode, a pattern code, a QR code or a text code. Thus, the identification code corresponding to each meal making process of each meal is unique. The user A and the operator B can be different people or the same person to preset and finish each meal making process of each kind of meal. For example, the user A can be a manager to preset each meal making process of each kind of meal, the operator B can be a clerk to finish the preset meal making process of each kind of meal.

As described, the pre-processing system 10 can be, for example, a POS terminal, and it can generate a unique identification code corresponding to each meal making process of each kind of meal. By reading the identification code, the information relevant to the meal can be obtained. For instance, the information may comprise the item of the meal (e.g., Americano), the size of the meal (e.g., medium or large), the additives, the sugar usage/sweetness (e.g., full sugar, half sugar, less sugar or sugar free), and the price. Moreover, taking a coffee making process for example, the needed equipment, which is a meal making machine, may comprise at least one grinder, a coffee/beverage machine, a syrup machine or more.

When a user presets each meal making process of each beverage item, he can use his tablet, smart phone, laptop or personal computer to make a list of all kinds of beverages and their corresponding identification codes. After that, for each kind of beverage, the user chooses corresponding meal making machines that are used in the meal making process of this beverage. Also, the user makes each needed meal making machine record a meal making process of this beverage, and record a relationship between an identification code of this beverage and the meal making process of this beverage.

For example, there are two grinders which are a grinder No. 1 and a grinder No. 2. The user can choose one of them to be used in the meal making process of a beverage. After that, the auto control system of this grinder No. 1 or grinder No. 2 can record a meal making process of this beverage, and can record a relationship between an identification code of this beverage and the meal making process of this beverage. Moreover, the same things can be done for other meal making machines that are needed in the meal making process of this beverage, such as a syrup machine or the like.

The equipment used in a meal making process of each meal has a communication module. Thus, by using a tablet, a smart phone, a computer or a POS terminal, the data of each meal making process can be wired or wirelessly transmitted to all equipment that may be used. After that, the auto control system of each making machine will store the received identification code and the corresponding meal making process.

The first processing device 22, the second processing device 24 and the third processing device 26 respectively have a scanner 23. One identification code is generated for one kind of beverage. This identification code is written in a tag and this tag is attached at a place easy to be scanned on a container. The first processing device 22, the second processing device 24 and the third processing device 26 can read the tag and further execute a corresponding meal making process. According to the above, the user can preset the processing machines to record each meal making process of each meal, and a relationship between an identification code of a meal and its meal making process. Thus, when the operator operates the processing machine, the processing machine can correctly execute the corresponding meal making process of the meal by the chosen meal making machines.

In one example, if there are coffee and tea provided in a beverage store, there may be a grinder, two beverage machines (e.g., a coffee machine and a tea-making machine), two syrup machines and the like in the store. Steps to preset each meal making process of each kind of beverage may be as follows.

Step 1: Making a list of all kinds of beverages and their corresponding identification codes, such as the table 1 as below.

TABLE 1

| Identification | | | |
|---|---|---|---|
| Code | Item | Size | Sugar Usage |
| 12340001 | Americano | Medium | Syrup Machine No. 1, half sugar, |
| | | | 20 g |
| 12340002 | Black Tea | Large | Syrup Machine No. 2, full sugar, |
| | | | 60 g |

Step 2: According to the list, for each kind of beverage, choosing one meal making machine in each processing machine and setting is as the equipment to be used in the meal making process. A user can use the setup unit 12 to execute step 2. The setup unit 12 can be, for example, a tablet, a personal computer or a POS terminal. Moreover, software can be installed in the setup unit 12 to execute step 2. Step 2 can be illustrated by the following table 2.

TABLE 2

| Identification | | | Beverage | |
|---|---|---|---|---|
| Code | Item | Grinder | Machine | Syrup Machine |
| 12340001 | Americano | Grinder No. 1 | Beverage | Syrup Machine |
| | | | Machine | No. 1 |
| | | | No. 1 | |
| 12340002 | Black Tea | None | Beverage | Syrup Machine |
| | | | Machine | No. 2 |
| | | | No. 2 | |

Step 3: Setting the meal making process for the Americano having an identification code “12340001” as shown in table 2, and the steps are as follows.

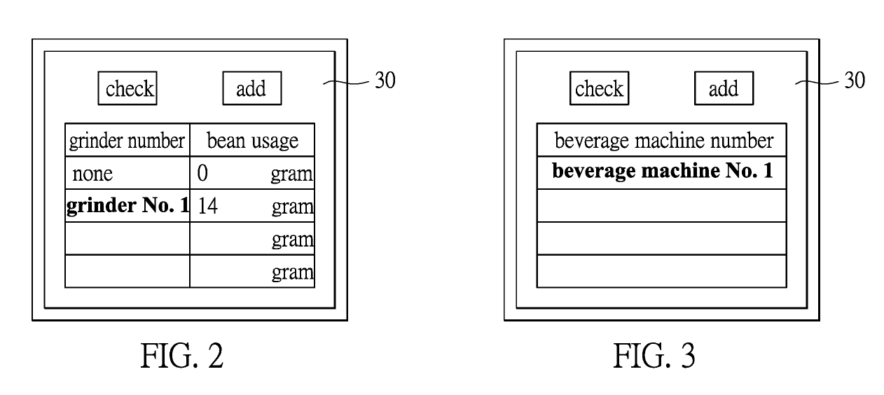

In step (a), the table 2 is displayed by the setup unit 12. A user clicks the identification “12340001” and chooses the grinder machine No. 1, and then a setup image of the grinder machine is displayed on the setup unit 12. The setup image of the grinder machine is shown as FIG. 2 wherein the grinder machine No. 1 is highlighted by a special color and there is a column showing the sugar usage of the beverage, such as 14 grams. After checking the sugar usage of the beverage, the user clicks the check button and the setup unit 12 again displays the table 2 with the grinder machine No. 1 highlighted by a special color (the grinder machine No. 1 is highlighted by a special color because the setting for the grinder machine No. 1 has been done). Additionally, to add another grinder and to set its bean usage, the user can click the add button shown in the setup image of the grinder machine and then set the bean usage for that newly added grinder. FIGS. 2-8 show schematic diagrams of a setup image of a grinder, a beverage machine and a syrup machine in one embodiment of the instant disclosure.

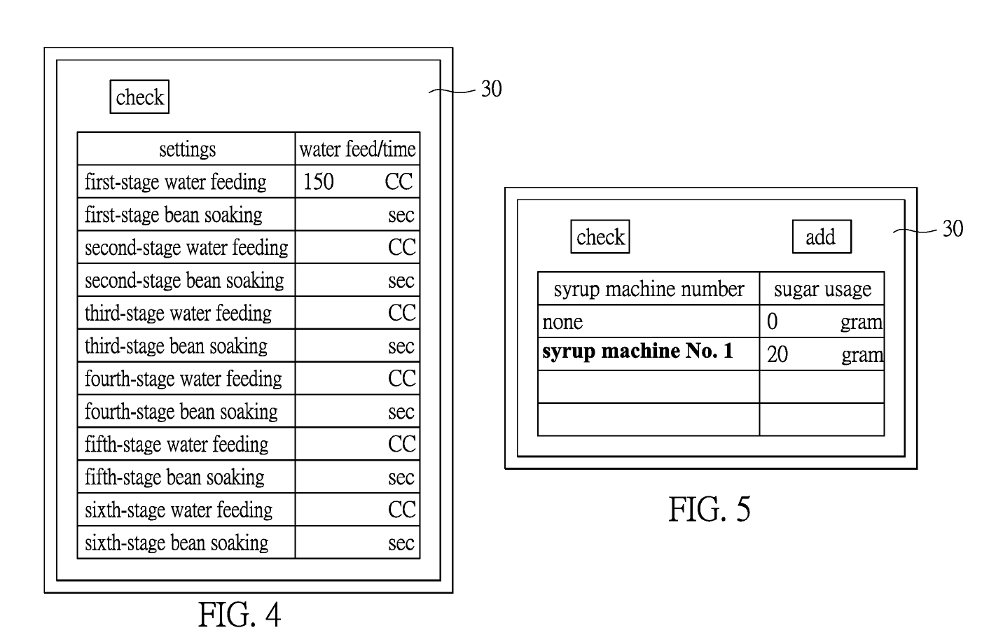

In step (b), a user clicks the identification “12340001” and chooses the beverage machine No. 1, and then a setup image of the beverage machine, as shown by FIG. 3, is displayed on the setup unit 12. After that, the user clicks the beverage machine No. 1 and the check button, the beverage machine No. 1 is then highlighted by a special color (with its font-weight being bold) and the setup image of the beverage machine is as shown by FIG. 4. In this setup image, there is a column for the user to set the water feed for the beverage, for example, the user can set 150 CC water feed for the beverage. After checking the water feed for the beverage, the user clicks the check button and the setup unit 12 again displays the table 2 with the beverage machine No. 1 highlighted by a special color (the beverage machine No. 1 is highlighted by a special color because the setting for the beverage machine No. 1 has been done).

In step (c), a user clicks the identification “12340001” and chooses the syrup machine No. 1, and then a setup image of the syrup machine, as shown by FIG. 5, is displayed on the setup unit 12. After that, the user clicks the syrup machine No. 1 and the syrup machine No. 1 is then highlighted by a special color (with its font-weight being bold) which indicates that the syrup machine No. 1 can be set now. As shown by FIG. 5, there is a column for the user to set the sugar usage of the beverage, for example, the user can set the sugar usage of the beverage to be 20 grams. After checking the sugar usage of the beverage, the user clicks the check button and the setup unit 12 again displays the table 2 with the syrup machine No. 1 highlighted by a special color (the syrup machine No. 1 is highlighted by a special color because the setting for the syrup machine No. 1 has been done).

Step 4: Setting the meal making process for the Black Tea having an identification code “12340002” as shown in table 2, and steps are as follows.

In step (a), the table 2 is displayed by the setup unit 12. A user clicks the identification “12340002” and chooses “none” shown in the column of the grinder because there is no need to use a grinder for making the black tea. After that, “none” shown in the column of the grinder is highlighted by a special color because the setting for not using a grinder has been done, and the table 2 is again shown by the setup unit 12.

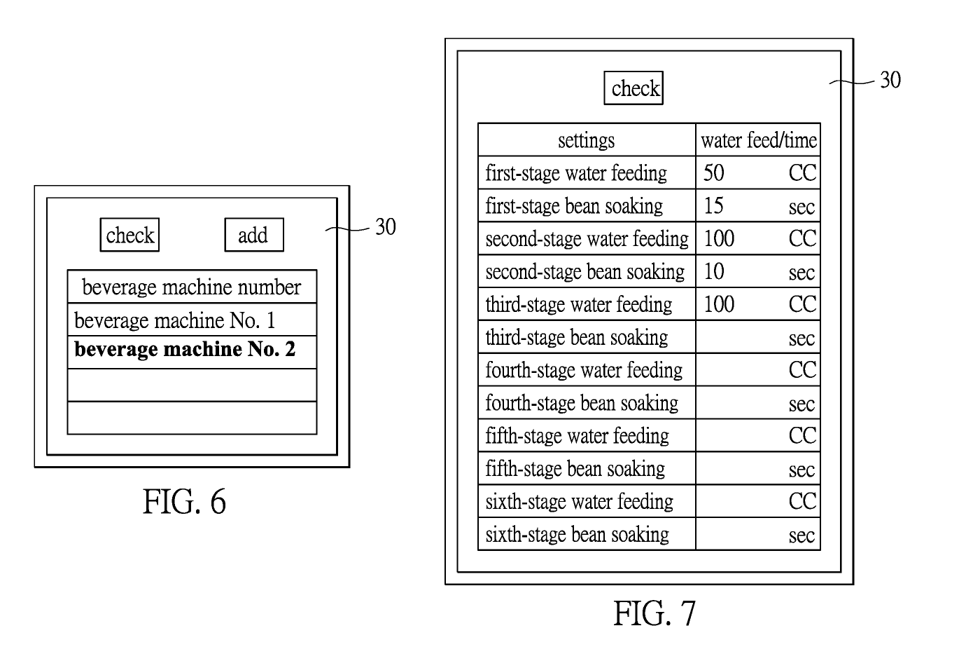

In step (b), a user clicks the identification “12340002” and chooses the beverage machine No. 2, and then a setup image of the beverage machine, as shown by FIG. 6, is displayed on the setup unit 12. The user then clicks the add button to add the beverage machine No. 2 and clicks the check button. The “beverage machine No. 2” is highlighted by a special color to indicate that the beverage machine No. 2 can be set now, and then the setup image of the beverage machine No. 2 is displayed by the setup unit 12, as shown by FIG. 7. In the setup image of the beverage machine No. 2, there is a column showing six-stages of the tea making process for the user to set the water feed and the tea soaking time for each stage of the tea making process. After setting the water feed and the tea soaking time for each stage of the tea making process, the user clicks the check button and the table 2 is again displayed by the setup unit 12. In the table 2, the “beverage machine No. 2” is highlighted by a special color to indicate that the setting for the beverage machine No. 2 has been done.

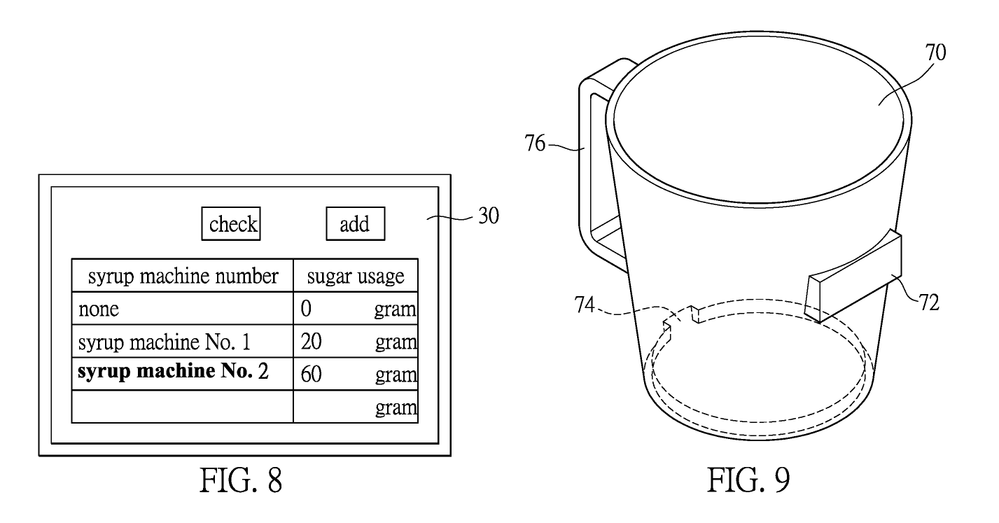

In step (c), a user clicks the identification “12340002” and chooses the syrup machine No. 2, and then a setup image of the syrup machine, as shown by FIG. 8, is displayed on the setup unit 12. The user clicks the “add” button to add in the syrup machine No. 2. As a result, the syrup machine No. 2 is added and shown with its font-weight being bold to show this syrup machine No. 2 is newly added. Then, the user inputs the sugar usage in the column of sugar usage for the syrup machine No. 2, such as 60 grams, and clicks the “check” button after double checking the above operation. The table 2 is again displayed by the setup unit 12, wherein the cell of the syrup machine No. 2 in the table 2 is highlighted by different color to show that the syrup machine No. 2 has been set.

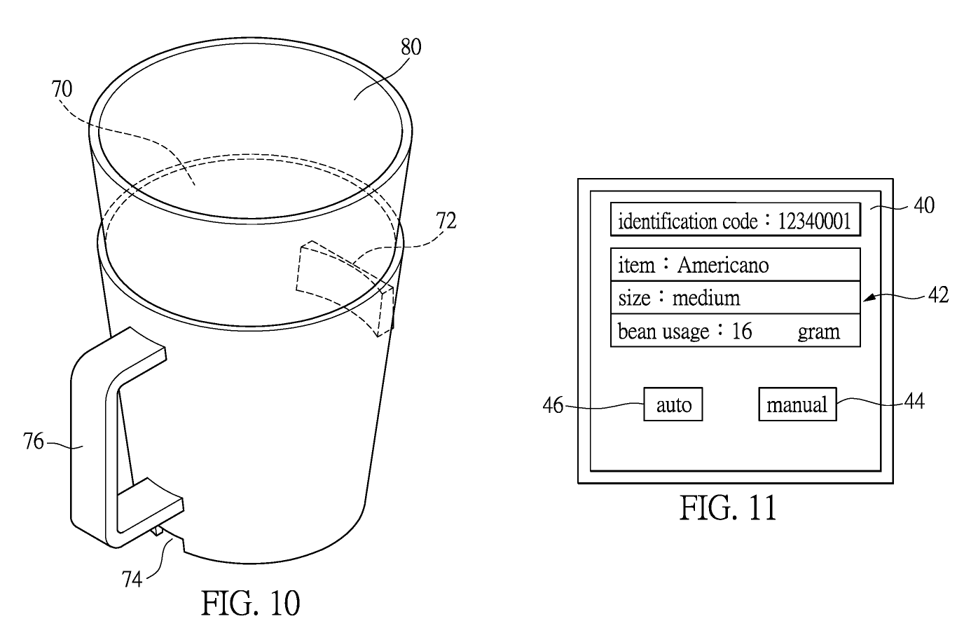

Referring to FIG. 9, FIG. 9 shows a schematic diagram of a tray device of one embodiment of the instant disclosure. Usually, the cups used by the beverage shop are cups made of paper or disposable cups made of other materials. It is hard to make an identification tag to be attached at a proper position on the cup. Thus, there is a tray device 70 provided in this embodiment. For example, the tray device 70 can be a cup sleeve. This tray device 70 should be able to make people easily put a container 80 in and take a container 80 out, such as a beverage cup. Referring to FIG. 10, FIG. 10 shows a schematic diagram of a tray device and a container of one embodiment of the instant disclosure. The tray device 70 has a tag attaching area 72 for the scanner 23 to scan. In this manner, the operator B can know where the identification tag should be attached to. In addition, the tray device 70 has a first positioning means 74 at its bottom. For example, this first positioning means 74 can be a concave portion. The first positioning means 74 is used with the second positioning means 25 of the first processing device 22, the second processing device 24 and the third processing device 26. In other words, the first positioning means 74 is a concave portion, the second positioning means 25 can be a convex portion, such that the tray device 70 accommodating the container 80 can be put on a proper position for the scanner 23 to easily read the identification tag. The tray device 70 has a holder 76 for the operator B to hold easily. The container 80 can be, for example, a beverage cup, a coffee cup, a meal bowl or a soup bowl.

In this embodiment, each meal making machine has an operation interface 27, such as a touch screen or a combination of a display device and some physical buttons. There is one scanner 23 configured for the meal making machines having the same function. In other words, there are three scanners 23 configured, one for each of the first processing device 22, the second processing device 24 and the third processing device 26 respectively. For example, one scanner 23 is configured for one grinder, another scanner 23 is configured for two beverage machines, and the other scanner 23 is configured for two syrup machines. The meal making process of the beverage, for example, comprises steps as follows.

Step 1: The pre-processing system 10 generates an identification tag with the identification code “12340001”, and the identification tag is attached at the tag attaching area 72. By using the first positioning means 24 and the second positioning means 25, the scanning precision of the scanner 23 can be increased.

Step 2: The scanner 23 of the grinder reads the identification tag with the identification code “12340001” and then the image displayed by the operation interface 27 is shown as FIG. 11. FIG. 11 shows a schematic diagram of an operation image of a grinder in one embodiment of the instant disclosure. The image shown as FIG. 11 is an operation interface 40 of the grinder, and the operation interface 40 of the grinder has a display column 42 and an auto button 46. When the auto button 46 is pushed, an auto control system of the grinder executes the meal making process of a medium cup of the Americano, wherein the meal making process of a medium cup of the Americano corresponds to the identification code “12340001”. In addition, the operation interface 40 of the grinder also has a manual button 44 for the operator B to operate manually.

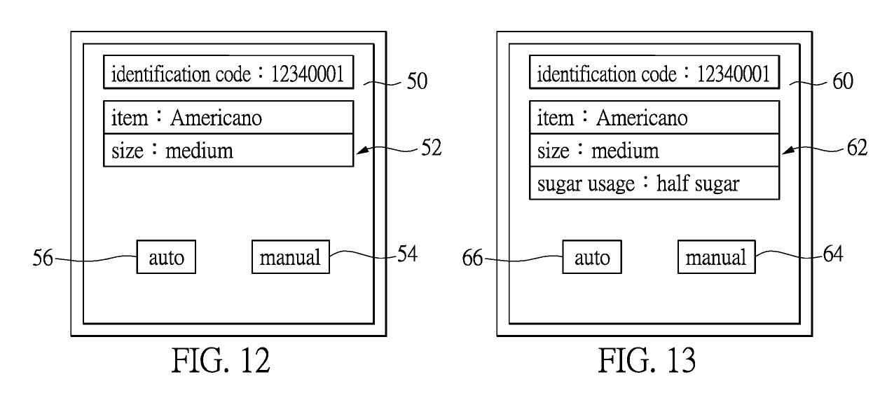

Step 3: The scanner 23 of the beverage machine reads the identification tag with the identification code “12340001”, and then the image displayed by the operation interface 27 is shown as FIG. 12. The image shown as FIG. 12 is an operation interface 50 of the beverage machine, and the operation interface 50 of the beverage machine has a display column 52, an auto button 56 and a manual button 54. When the auto button 56 is pushed, an auto control system of the beverage machine No. 1 executes the meal making process of a medium cup of the Americano.

Step 4: The scanner 23 of the syrup machine reads the identification tag with the identification code “12340001”, and then the image displayed by the operation interface 27 is shown as FIG. 13. The image shown as FIG. 13 is an operation interface 60 of the syrup machine, and the operation interface 60 of the syrup machine has a display column 62, an auto button 66 and a manual button 64. When the auto button 66 is pushed, an auto control system of the syrup machine No. 1 executes the meal making process of a medium cup of the Americano with half sugar.

Step 5: The meal making process of a medium cup of the Americano with half sugar has been completed, and the operator B or the clerk continues to operate the system to make the next ordered meal.

In another embodiment, each meal making machine 22a, 22b, 24a, 24b, 26a and 26b has an operation interface 27, such as a touch screen or a combination of a display device and some physical buttons. There is one scanner 23 configured for the meal making machines having the same function. In other words, there are three scanners 23 configured for the first processing device 22, the second processing device 24 and the third processing device 26 respectively. For example, one scanner 23 is configured for one grinder, another scanner 23 is configured for two beverage machines, and the other scanner 23 is configured for two syrup machines. The meal making process of the beverage, for another example, comprises steps as follows.

Step 1: The pre-processing system 10 generates an identification tag with the identification code “12340002”, and the identification tag is attached to the tag attaching area 72. By using the first positioning means 24 and the second positioning means 25, the scanning precision of the scanner 23 can be increased.

Step 2:

(a) The black tea is made from a prepared tea bag, so there is no grinder needed and the beverage machine can directly execute the meal making process of a cup of black tea.

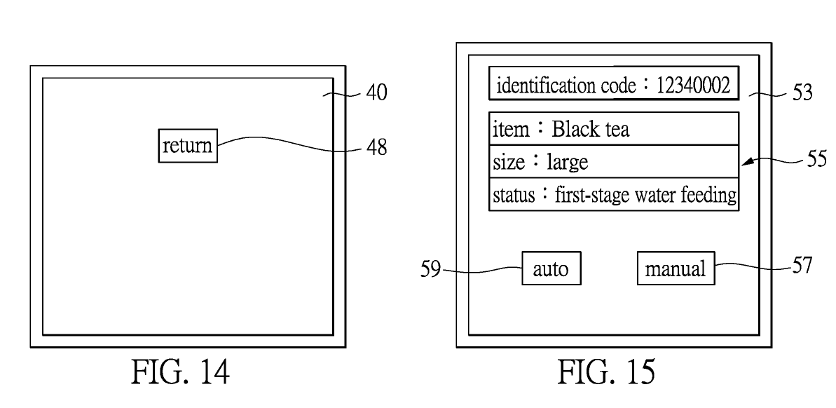

(b) If the operator B is not familiar with the meal making process of a cup of black tea, and he uses the scanner 23 of the grinder scans the identification tag with the identification code “12340002”, and then the image displayed by the operation interface 27 is shown as FIG. 14. The image shown as FIG. 14 is an operation interface of the grinder. However, there is no meal making process corresponding to the identification code “12340002” stored in the grinder, so there is a home button 48 displayed in the operation interface of the grinder. When the home button 48 is pushed, a standby image of the grinder is displayed.

Step 3: The scanner 23 of the beverage machine reads the identification tag with the identification code “12340002”, and then the image displayed by the operation interface 27 is shown as FIG. 15. The image shown as FIG. 15 is an operation interface 53 of the beverage machine No. 2, and the operation interface 53 of the beverage machine No. 2 has a display column 55, an auto button 59 and a manual button 57. When the auto button 59 is pushed, an auto control system of the beverage machine No. 2 executes the meal making process of a large cup of the black tea.

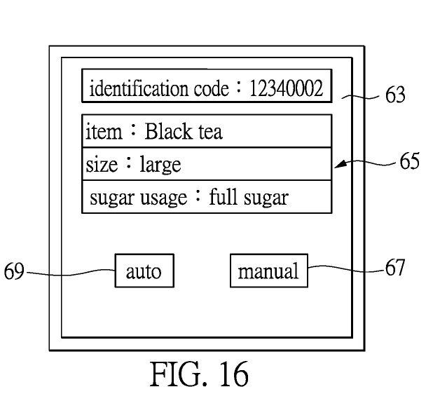

Step 4: The scanner 23 of the beverage machine reads the identification tag with the identification code “12340002”, and then the image displayed by the operation interface of the syrup machine No. 2 is shown as FIG. 16. The image shown as FIG. 16 is an operation interface 63 of the syrup machine No. 2, and the operation interface 63 of the syrup machine No. 2 has a display column 65, an auto button 69 and a manual button 67. When the auto button 69 is pushed, an auto control system of the syrup machine No. 2 executes the meal making process of a large cup of the black tea with full sugar.

Step 5: The meal making process of a large cup of the black tea with full sugar has been completed, and the operator B or the clerk continues to operate the system to make the next ordered meal.

To sum up, a meal making system is provided by the instant disclosure. This meal making system is easy to operate, and thus it takes less time to train new employees. Also, there is less possibility that the clerks make mistakes when operating the meal making system. Moreover, all data generated when a meal is made will be automatically recorded as references, and if necessary any needed equipment can be added to this meal making system. This meal making system can be connected to any POS system. There is only one auto button on each operation interface of each piece of equipment or each meal making machine. Each identification code refers to one meal making process, so by recognizing the identification code the meal making system knows which meal making process should be executed. Thus, there is less room for operation errors.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A meal making system, comprising:
a pre-processing system, comprising a setup unit for a user to preset each meal making process of each kind of meal, wherein an identification code is correspondingly generated after the user finishes presetting each meal making process of each kind of meal; and
a post-processing system, comprising a plurality of processing devices and receiving each preset meal making process of each kind of meal from the pre-processing system, wherein an operator operates the processing devices to finish each preset meal making process of each kind of meal, and each processing device comprises at least one meal making machine for the operator to execute the steps of each preset meal making process;
wherein the processing device further comprises:
a scanner, scanning the identification code of each meal making process of each kind of meal;
wherein the meal making machine comprises:
an operation interface, displaying the steps of each preset meal making process for the operator to operate;
wherein during the time when the operator operates the processing devices to finish the preset meal making process, the scanner scans the identification code, the operation interface displays the corresponding steps of the preset meal making process, and the operator operates the operation interface to finish all steps of the preset meal making process, wherein the system specifications of the pre-processing system and the post-processing system are the same or different.

2. The meal making system according to claim 1, wherein the identification code is a barcode, a pattern code, a QR code or a text code.

3. The meal making system according to claim 1, wherein the user and the operator are different people or the same person to preset and finish each meal making process of each kind of meal.

4. The meal making system according to claim 1, wherein the pre-processing system is a POS terminal, a laptop or a personal computer.

5. The meal making system according to claim 1, wherein the setup unit is a smart phone, a tablet or a POS terminal.

6. The meal making system according to claim 1, wherein the processing devices comprise:
a first processing device, comprising a first meal making machine and a second meal making machine;
a second processing device, comprising a third meal making machine and a fourth meal making machine; and
a third processing device, comprising a fifth meal making machine and a sixth meal making machine;
wherein the first meal making machine and the second meal making machine are a first grinder and a second grinder, the third meal making machine and the fourth meal making machine are a first beverage machine and a second beverage machine, and the fifth meal making machine and the sixth meal making machine are a first syrup machine and a second syrup machine.

7. A meal making system, comprising:
a pre-processing system, comprising a setup unit for a user to preset each meal making process of each kind of meal, wherein an identification code is correspondingly generated after the user finishes presetting each meal making process of each kind of meal;
a plurality of tray devices, wherein each identification code is attached at a predetermined position on the tray device, and each tray device has a first positioning means; and
a post-processing system, comprising a plurality of processing devices and receiving each preset meal making process of each kind of meal from the pre-processing system, wherein an operator operates the processing devices to finish each preset meal making process of each kind of meal, and each processing device comprises at least one meal making machine for the operator to execute steps of each preset meal making process;
wherein the processing device comprises:
a scanner, scanning the identification code of each meal making process of each kind of meal; and
a second positioning means, wherein the tray device is correctly oriented by the interaction between the first positioning means and the second positioning means;
wherein the meal making machine comprises:
an operation interface, displaying the steps of each preset meal making process for the operator to operate;
wherein during the time when the operator operates the processing devices to finish the preset meal making process, the tray device is oriented by the first positioning means and the second positioning means, the scanner scans the identification code, the operation interface displays the corresponding steps of the preset meal making process, and the operator operates the operation interface to finish all steps of the preset meal making process, wherein the system specifications of the pre-processing system and the post-processing system are the same or different.

8. The meal making system according to claim 7, wherein the identification code is a barcode, a pattern code, a QR code or a text code.

9. The meal making system according to claim 7, wherein the tray device supports a container and the container is a beverage cup, a coffee cup, a meal bowl or a soup bowl.

10. The meal making system according to claim 7, wherein the processing devices comprise:
a first processing device, comprising a first meal making machine and a second meal making machine;
a second processing device, comprising a third meal making machine and a fourth meal making machine; and
a third processing device, comprising a fifth meal making machine and a sixth meal making machine;
wherein the first meal making machine and the second meal making machine are a first grinder and a second grinder, the third meal making machine and the fourth meal making machine are a first beverage machine and a second beverage machine, and the fifth meal making machine and the sixth meal making machine are a first syrup machine and a second syrup machine.
